(19) United States
(12) Patent Application Publication
(10) Pub. No.: US 2019/0384355 A1
(43) Pub. Date: Dec. 19, 2019

(54) WEARABLE CONTROLLER

(71) Applicant: Jae Hong Park, Seoul (KR)

(72) Inventor: Jae Hong Park, Seoul (KR)

(21) Appl. No.: 16/464,666

(22) PCT Filed: Nov. 8, 2017
(86) PCT No.: PCT/KR2017/012582

§ 371 Date: May 28, 2019

(30) Foreign Application Priority Data
Dec. 5, 2016 (KR) 10-2016-0164585

(51) Int. Cl. G06F 1/16; G06F 3/041; G06F 3/0346; G06F 3/0338

(52) U.S. Cl. CPC G06F 1/163; G06F 3/0338; G06F 3/0346; G06F 3/041

(57) ABSTRACT

Provided is a wearable controller. The wearable controller includes a main body worn on a user's hand at least one operating unit for operating an external device and a control unit including a communication module for transmitting control information generated by the operating unit to the external device. The main body includes a lower support disposed at a position corresponding to a lower end of a user's wrist to support the lower end of the user's wrist an upper support disposed at a position corresponding to any region of an upper end of the user's wrist to the back of the user's hand a palm support disposed at a position for supporting the palm of a user and a connection member connecting the lower support, the palm support and the upper support such that the wearable controller does not escape from the user's hand.

### TECHNICAL FIELD

The following disclosure relates to a wearable controller.

### BACKGROUND ART

A controller allows a device to perform its functions by commanding the device from a remote place. The basic purpose of the controller is to ensure the convenience of the operation of a device, thereby solving inconvenience for a user to move to the device and operate the device by pressing a button.

A controller may be implemented in various forms or structures according to a device to be remotely operated. One example is a remote control for operating a television, which includes various function buttons associated with channel changes or, audio or video settings, and mainly has hand-held forms. As another example, there is a wired/wireless game controller including separate key buttons, direction selection buttons, etc. for game operation.

However, since related-art controllers need to be operated while being gripped by the hand of a user, a user cannot perform other tasks with their hand gripping the controller. In addition, since various hand gestures, postures, and position changes of a user cannot be recognized, various types of operations are difficult.

Korean Patent Application Publication No. 10-2013-0042326 discloses an attempt to enable various manipulation methods.

However, since a user needs to maintain the posture while holding a controller with one hand or both hands at the time of operation, the operation posture is unnatural and inconvenience is incurred when a user uses the controller for a long time. Particularly, there is a limitation in that when used for a long time, the controller may cause the pain of the neck or shoulder of a user.

### DISCLOSURE

### Technical Problem

Accordingly, the present disclosure provides a wearable controller which can be used in a natural posture while being worn on a user's hand and can support various types of input.

### Technical Solution

In one general aspect, a wearable controller includes: a main body worn on a user's hand; at least one operating unit for operating an external device; and a control unit including a communication module for transmitting control information generated by the operating unit to the external device.

In this case, the main body may include: a lower support disposed at a position corresponding to a lower end of a user's wrist to support the lower end of the user's wrist; an upper support disposed at a position corresponding to any region of an upper end of the user's wrist to the back of the user's hand; a palm support disposed at a position for supporting the palm of a user; and a connection member connecting the lower support, the palm support and the upper support such that the wearable controller does not escape from the user's hand. Other features and aspects will be apparent from the following detailed description, the drawings, and the claims.

### Advantageous Effects

According to an embodiment of the present invention, a wearable controller can be easily used for a long period of time in various postures while being worn on a user's hand, thereby minimizing fatigue during long-time use.

In addition, the wearable controller can be variously utilized for augmented reality, virtual reality-based wearable controller, a drone controller, and an in-home wired/wireless game controller by supporting various inputs according to a user's hand motion, posture, or position change.

### DESCRIPTION OF DRAWINGS

FIG. 1 is a perspective view illustrating a wearable controller according to an embodiment of the present invention.

FIG. 2 is a view illustrating a wearable controller according to an embodiment of the present invention.

FIG. 3 is a view illustrating a wearable controller worn on the hand of a user according to an embodiment of the present invention.

FIG. 4 is a front view and a partial cross-sectional view illustrating a wearable controller according to an embodiment of the present invention.

FIG. 5 is a view illustrating a display unit worn on a wearable controller according to an embodiment of the present invention.

*List of reference numbers in the drawings*

| | |
|---|---|
| 10: wearable controller | 20: external device |
| 100: main body | |
| 110: lower support | 111: separation preventing part |
| 120: upper support | 121: information display unit |
| 130: palm support | 131: expansion port |
| 140: connection member | 141: connection part |
| 142: link part | 143: upper link park |
| 144: lower link part | 145: insertion depth adjusting part |
| 146: mixing protrusion | 147: fixture |
| 200: operating unit | |
| 210: button | 220: joystick |
| 300: control unit | |
| 310: communication moudle | |
| 400: display unit | 500: motion sensing unit |
| 600: state sending unit | 700: notification unit |

### BEST MODE

Hereinafter, exemplary embodiments of the present invention will be described in detail with reference to the accompanying drawings, which will be readily apparent to those skilled in the art. The present invention may, however, be embodied in many different forms and should not be construed as limited to the embodiments set forth herein. In order to clearly describe the present invention, parts unrelated to the description are omitted in the drawings, and like parts are denoted by like reference numerals throughout the specification.

Throughout this specification, when a part is referred to as being “connected” to another part, this does not include only a case where it is “directly connected” but also includes a case where it is “electrically connected” across another element.

Throughout this specification, when a member is located “on” another member, this does not include only a case where the member is in contact with another member, but also includes a case where another member exists between the two members.

Throughout this specification, when an element is referred to as “including/comprising” an element, it is understood that it may include other elements as well, without departing from the other elements unless specifically stated otherwise. The terms “about”, “substantially”, etc. used to mean the extent throughout this specification are used in numerical values or in close proximity to the numerical values when unique manufacturing and material tolerances are presented in the mentioned meaning, and are used to prevent an unscrupulous infringer from exploiting the disclosed content in which precise or absolute numerical values are mentioned to help understanding of the present invention. The term “step” or “step of ˜” used throughout the specification does not mean “step for ˜”.

The present invention relates to a wearable controller 10. For example, the wearable controller 10 may be a device that is connected to an external device 20 through a communication module 310 and controls the external device 20. However, the present invention is not limited thereto, and the wearable controller 10 and the external device 20 may be connected to each other through a connector.

The external device 20 described above may be a home appliance, a game machine, a drone, a virtual reality device, and an augmented reality device, but is not limited thereto.

The wearable controller 10 according to this embodiment may be a device that is worn on a user's hand and transmits an input signal generated by a user manipulating the operating unit 200 or adjusting the inclination of the controller 10 to the external device 20.

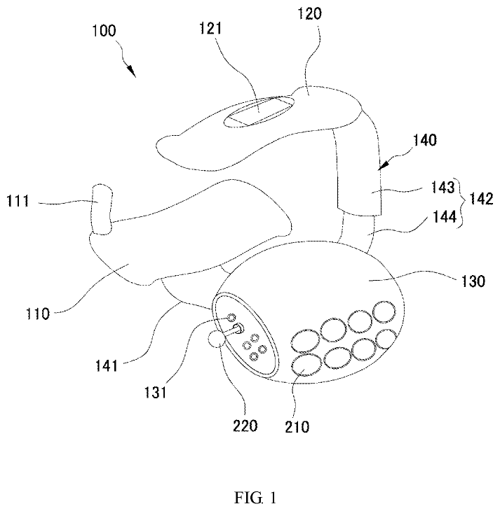

First, a wearable controller 10 according to an embodiment of the present invention will be described with reference to FIGS. 1 to 3.

The wearable controller 10 includes a main body 100 worn on a user's hand, at least one operating unit 200 for operating an external device 20, and a control unit 300 including a communication module 310 for transmitting control information generated by the operating unit 200 to the external device 20.

The control unit 300 may not only transmit the control information to the external device 20 but may also transmit information transmitted from the external device 20 to an information display unit 121, a display unit 400, and a notification unit 700 described later.

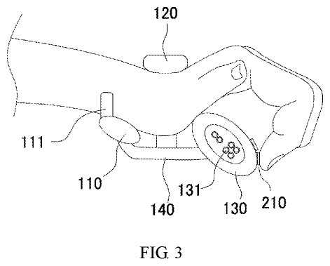

Referring to FIG. 3, the wearable controller 10 may be worn on a user's hand to control the external device 20 through the operating unit 200.

To this end, the main body 100 includes a lower support 110 disposed at a position corresponding to a lower end of a user's wrist to support the lower end of the user's wrist, an upper support 120 disposed at a position corresponding to any region of an upper end of the user's wrist to the back of the user's hand, a palm support 130 disposed at a position for supporting the palm of a user, and a connection member 140 connecting the lower support 110, the palm support 130 and the upper support 120 such that the wearable controller 10 does not escape from the user's hand. The region of the upper end of the user's wrist to the back of the user's hand may mean an area which is not disturbed so as to freely move the wrist from the upper end of the wrist to the back of the hand, preferably, an upper portion of the wrist joint.

In other words, when a user inserts the user's hand between the lower support 110, the palm support 130 and the upper support 120 through one side of the main body 100, the lower support 110 may support the lower part of the wrist, and the upper support 120 may be located between the upper part of the wrist and the back of the hand. Also, the palm support 130 may support the palm.

In other words, the wearable controller 10 may be fixed to the hand of a user through the three supports, i.e., the lower support 110, the upper support 120, and the palm support 130, while the upper support 120 is disposed over the wrist (or at a boundary region between the wrist and the back of the hand), allowing a user to rotate the wrist at a free angle. That is, a user can freely operate the wearable controller 10. Also, in order to locate the respective supports 110, 120 and 130 at the corresponding body parts, a first separation distance between the upper support 120 and the lower support 110 is configured to be shorter than a second separation distance between the palm support 130 and the lower support 110 based on the longitudinal direction of a connection part 141. Accordingly, even if a user uses the wearable controller 10 for a long period of time in various environments and various postures, fatigue on the wrist, neck, and shoulder can be significantly reduced. For example, the lower support 110, the palm support 130, and the upper support 120 may be formed of a flexible silicone so as not to put stress on the wrist and palm, but the present invention is not limited thereto.

The surface of the lower support 110 which faces the lower portion of the wrist, that is, makes contact with the lower portion of the wrist may have an inwardly recessed shape, and the surface of the upper support 120 which faces the upper portion of the wrist, that is, makes contact with the upper portion of the wrist may have an inwardly recessed shape. Accordingly, when the wearable controller 10 is worn, the wrist can be seated in the recessed area, and the wearable controller 10 can be stably used.

In addition, the lower support 110 may include a separation preventing part 111 located at the inner side of the wrist of a user. For example, the separation preventing part 111 may be coupled to the lower support 110 by a hinge. When a user does not use the wearable controller 10, the separation preventing part 111 may be folded and stored, and when the hand of a user is inserted, the separation preventing part 111 may be rotated to prevent the hand of a user from being separated and the wearable controller 10 can be firmly fixed to the hand of a user.

In addition, the palm support 130 may be formed in a cylindrical shape having an oval cross-section elongated in the width direction, and user's fingers may wind or hold the palm support 130. In this case, the palm support 130 does not exceed the center of the palm of the hand for the comfort of the hand, and when the finger is bent in consideration of the finger length, a button 210 or a touch screen described later may be located at a portion which the tip of the finger is located at.

A detailed description thereof will be made later.

The lower support 110, the palm support 130, and the upper support 120 may be connected to each other via a connection member 140.

The connection member 140 may include a connection part 141 formed at a location corresponding to the palm of a user and connecting the palm support 130 and the lower support 110 and a link part 142 curvedly formed while covering one region of the hand so as to be connected to the connection part 141 and the upper support 120. The covering of the region of the hand by the link part 142 may mean that the link part 142 is connected to the connection part 141 and the upper support 120 while locating at the opposite side of the thumb when the wearable controller 10 is worn on the hand of a user.

As shown in FIG. 3, one end of the connection part 141 is connected to the palm support 130, and the other end of the connection part 141 is connected to the lower support 110. Also, the connection part 141 may be bent in a downward direction so as not to interrupt the wearing of the wearable controller 10.

Also, the palm support 130 may be rotatably connected to the connection member 140. In this case, a motion sensing unit 500 capable of sensing motion is located inside the palm support 130, and the motion information of the palm support 130 may be transmitted to the external device 20 through the communication module 310. A detailed description thereof will be made later.

The lower support 110 may be formed to obliquely extend at an acute angle of 0 to 90 degrees with respect to the connection part 141 when the direction and position of the connection part 141 extending in the longitudinal direction is 0 degree. According to such an oblique structure, the lower support 110 can more firmly press and support the lower end of a user's wrist.

Also, the palm support 130 may be formed in a cylindrical structure of an oval cross-section, and the major axis of the oval cross-section may be obliquely connected to have an acute angle of 0 to 90 degrees with respect to the connection part 141. This obliquely connected structure may allow the palm of the hand to grip the palm support with a sense of grip and may prevent the controller from escaping from the wrist.

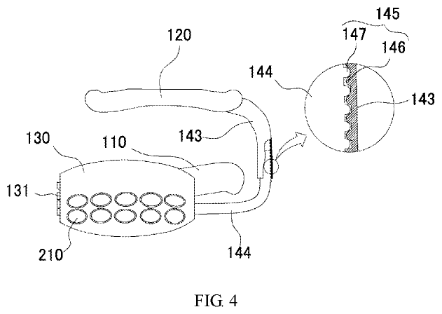

Referring to FIG. 4, the link part 142 may include an upper link part 143 bent at a certain angle in a direction from the back of the user's hand toward the palm of the user's hand and having an insertion hole formed at one end thereof facing the palm, and a lower link part 144 bent at a certain angle in a direction from the palm of the user's hand toward the back of the user's hand and having one end thereof inserted into the insertion hole of the upper link part 143 and the other end thereof connected to the connection part 141. Without being limited thereto, however, an insertion hole may be formed at one end of the lower link part 144 facing the back of the hand, and one end of the upper link part 143 may be inserted into the insertion hole of the lower link part 144.

Without being limited thereto, however, the lower support 110 and the palm support 130 may be integrally formed as one unit. In this case, the connection member 140 may connect the lower support 110 and the palm support 130 integrally formed with the upper support 120.

### MODE FOR INVENTION

Hereinafter, the insertion depth adjusting part 145 according to an embodiment of the present invention will be described with reference to FIG. 4.

The link part 142 may include an insertion depth adjusting part 145 for adjusting the depth at which the lower link part 144 is inserted into the insertion hole of the upper link part 143. In other words, in the wearable controller 10, a distance between the lower support 110 and the palm support 130 and the upper support 120 may be adjusted by adjusting the depth of insertion of the lower link part 144 into the insertion hole of the upper link part 143 according to the thickness of a user's hand.

Referring to FIG. 4, the insertion depth adjusting part 145 may include at least one fixing protrusion 146 formed at one end of the lower link part 144 bent toward the back of the hand and protruding at a certain interval, and at least one fixture 147 formed on the inner surface of the insertion hole of the upper link part 143 and protruding at a location corresponding to the fixing protrusion 146.

The insertion depth adjusting part 145 may be formed in the trapping type as described above, but the present invention is not limited thereto, and may be configured in various ways such as a fastening type, a coupling type, a clamping type, a clip type, and the like.

Referring to FIG. 3, the operating unit 200 may be configured with a button 210 or a touch screen (not shown) located at a region of the palm support 130 that is spaced apart from a region corresponding to the palm of a user and generating an input signal by pressurization of a user's finger.

In other words, when a user wears the wearable controller 10, a user can control the external device 20 by bending the finger and manipulating the button 210 or the touch screen located on the palm support 130. The operating unit 200, for example, the button 210 or the touch screen may be formed on the surface opposite to the surface facing the upper support 120 and the lower support 110.

The wearable controller 10 may include a motion sensing unit 500 including at least one of a gyro sensor, an acceleration sensor, an angular velocity sensor, and a geomagnetic sensor capable of sensing movement of the wearable controller 10.

The motion sensing unit 500 may be located at least one of the lower support 110, the upper support 120, the palm support 130 and the connection member 140 of the main body 100 to sense the motion of the wearable controller 10.

For example, the motion sensing unit 500 may be located at the palm support 130 as described above, and in this case, a user may rotate the palm support 130 to transmit motion information to external device 20 through the communication module 310, thereby controlling the external device 20.

The upper support 120 may include an information display unit 121 located on the upper surface thereof and displaying information. For example, the information display unit 121 may display state information of the wearable controller 10 and surrounding environments such as battery information, connection state information, and setting information, and may also display image information transmitted from the external device 20.

The upper support 120 or the palm support 130 may further include at least one expansion port 131 to which an expansion device is connected. As shown in FIG. 1, the expansion port 131 may be located at a side portion of the palm support 130, but the present invention is not limited thereto. Also, the expansion port 131 may be located at an upper portion of the upper support 120, and a display unit 400 described later may be connected to the expansion port 131 of the upper support 120.

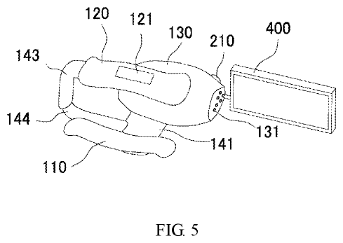

Referring to FIGS. 1 and 5, the wearable controller 10 may further include a display unit 400 or a joystick 220 connected to the expansion port 131.

For example, the wearable controller 10 may be a drone controller that controls a drone. In this case, the flight of the drone may be controlled through the joystick 220 of the wearable controller 10, and image data transmitted through a camera module mounted on the drone may be displayed on the display unit 400.

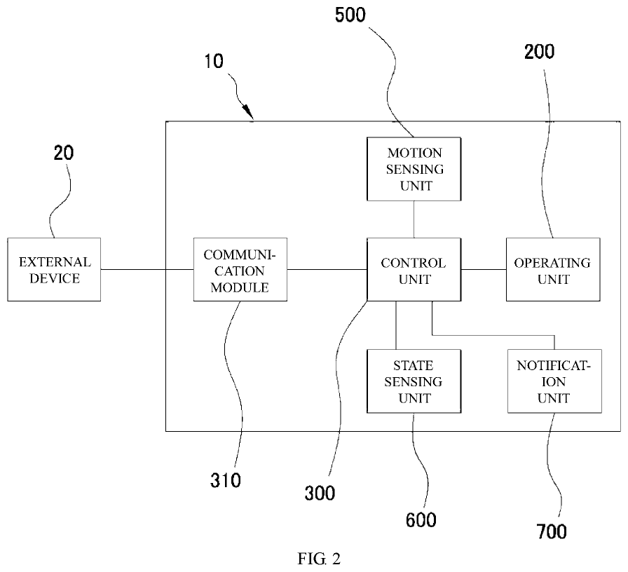

Referring FIG. 2, the wearable controller 10 may further include a state sensing unit 600 for sensing a surrounding environment or a state of a user, and a notification unit 700 providing a notification signal to a user. In this case, the surrounding environment may mean various kinds of environmental factors around the wearable controller 10, e.g., presence of light, amount of light, presence and size of sound, presence and operation of external objects, and the like.

The state sensing unit 600 may include at least one of an optical sensor for sensing light, an acoustic sensor for sensing sound, a temperature sensor for sensing temperature, and a bio-signal sensor for sensing a user's body temperature, pulse, and respiratory rate or heart rate per minute.

The optical sensor may detect external light and collect situation information about the surrounding environment. Specifically, the optical sensor may sense the amount of light (quantity of light) or detect the presence or absence of an external object and the operation or shape of the object by sensing light in the surrounding environment, and may convert the detected results into electrical signals to obtain the situation information about the surrounding environment. For example, the optical sensor may be formed of a photodiode or phototransistor that converts light into an electrical signal, or may be formed of an InfraRed Emitting Diode (IRED) that converts infrared light into an electrical signal, but the present invention is not limited thereto.

The acoustic sensor may detect voice or sound around the wearable controller 10, and may measure the voice or sound to obtain the situation information about the surrounding environment. For example, the acoustic sensor may detect a wave of a certain frequency transmitted through the air using a transducer or the like, and may convert the detected wave into an electrical signal to obtain state information on various voices and sounds in the surrounding environment.

The temperature sensor may be a sensor that measures the temperature by measuring the ambient air or the heat of a contacted object. For example, the temperature sensor may include a platinum resistance thermometer, a thermistor, a thermocouple, and other sensors capable of measuring an external temperature. In addition, the temperature sensor may check whether the temperature around the wearable controller 10 is high or low.

The bio-signal sensor may sense information related to the physical condition of a user. For example, the bio-signal sensor may be located at a wrist support to measure the pulse or body temperature of a user, and may display such information on the information display unit 121 or the display unit 400 described above.

The wearable controller 10 may further include a notification unit 700 including at least one of a light emitting module that emits light, a vibration module that generates vibration, a sound module that outputs sound, and a temperature control module that controls temperature.

The light emitting module may output a certain light to the outside by emitting a light emitting body according to a light emitting control command transmitted from the control unit 300. For example, the light emitting module may include a light emitting body such as a light emitting diode mounted on the outer surface of the wearable controller 10, and a circuit for controlling the light emitting body. Also, the light emitting module may output light of different colors or different energies, or may output light in different patterns according to a determination result based on the situation information.

The vibration module generates vibration for the wearable controller 10 according to the determination result based on the situation information. For example, the vibration module may vibrate the wearable controller 10 using a vibration motor installed in the wearable controller 10. Also, the vibration module may generate vibration of different intensities or may change the vibration pattern based on the determination result, thereby enabling a user to recognize the determination result.

The sound module may output a certain sound, music, or recorded voice according to the determination result based on the situation information and thus notify a user of the determination result. For example, the sound module allows the sound to be outputted through a speaker.

The temperature control module may change the temperature of the wearable controller 10 according to the determination result based on the situation information, and thus notify a user of the determination result.

It will be understood by those skilled in the art that the foregoing description of the present invention is for illustrative purposes only, and those of ordinary skill in the art can readily understand that various changes and modifications may be made without departing from the technical spirit or essential characteristics of the present invention. Therefore, it should be understood that the above-described embodiments are illustrative in all aspects and not restrictive. For example, each component described as a single form may be dividedly implemented, and components described as being divided may also be implemented in a combined form.

The scope of the present invention is defined by the appended claims rather than the detailed description, and all changes or modifications derived from the meaning and scope of the claims and their equivalents should be construed as being included within the scope of the present invention.

1. A wearable controller comprising:
a main body worn on a user's hand; at least one operating unit for operating an external device; and
a control unit comprising a communication module for transmitting control information generated by the operating unit to the external device,
wherein the main body comprises:
a lower support disposed at a position corresponding to a lower end of a user's wrist to support the lower end of the user's wrist;
an upper support disposed at a position corresponding to any region of an upper end of the user's wrist to the back of the user's hand;
a palm support disposed at a position for supporting the palm of a user; and
a connection member connecting the lower support, the palm support and the upper support such that the wearable controller does not escape from the user's hand.

2. The wearable controller of claim 1, wherein the connection member comprises:
a connection part formed at a location corresponding to the palm of a user and connecting the palm support and the lower support; and
a link part curvedly formed while covering one region of the hand so as to be connected to the connection part and the upper support.

3. The wearable controller of claim 2, wherein the link part comprises:
an upper link part bent at a certain angle in a direction from the back of the user's hand toward the palm of the user's hand and having an insertion hole formed at one end thereof facing the palm;
a lower link part bent at a certain angle in a direction from the palm of the user's hand toward the back of the user's hand and having one end thereof inserted into the insertion hole of the upper link part and the other end thereof connected to the connection part; and
an insertion depth adjusting part for adjusting the depth at which the lower link part is inserted into the insertion hole of the upper link part.

4. The wearable controller of claim 3, wherein the insertion depth adjusting part comprises:
at least one fixing protrusion formed at one end of the lower link part bent toward the back of the hand and protruding at a certain interval; and
at least one fixture formed on the inner surface of the insertion hole of the upper link part and protruding at a location corresponding to the fixing protrusion.

5. The wearable controller of claim 2, wherein the lower support is formed to obliquely extend at an acute angle of 0 to 90 degrees with respect to the connection part when the direction and position of the connection part extending in the longitudinal direction is 0 degree, and the palm support is formed in a cylindrical structure of an oval cross-section whose major axis is obliquely connected to have an acute angle of 0 to 90 degrees with respect to the connection part.

6. The wearable controller of claim 1, wherein the palm support is rotatably connected to the connection member.

7. The wearable controller of claim 1, further comprising a motion sensing unit comprising at least one of a gyro sensor, an acceleration sensor, an angular velocity sensor, and a geomagnetic sensor capable of sensing movement of the wearable controller,
wherein the operating unit comprises a button or a touch screen located at a region of the palm support that is spaced apart from a region corresponding to the palm of a user and generating an input signal by pressurization of a user's finger.

8. The wearable controller of claim 1, wherein the upper support or the palm support further comprises at least one expansion port to which an expansion device is connected and a display unit or a joystick connected to the expansion port.

9. The wearable controller of claim 1, further comprising a state sensing unit for sensing a surrounding environment or a state of a user,
wherein the state sensing unit comprises at least one of an optical sensor for sensing light, an acoustic sensor for sensing sound, a temperature sensor for sensing temperature, and a bio-signal sensor for sensing a user's body temperature, pulse, and respiratory rate or heart rate per minute.

10. The wearable controller of claim 1, further comprising a notification unit comprising at least one of a light emitting module that emits light, a vibration module that generates vibration, a sound module that outputs sound, and a temperature control module that controls temperature.

11. The wearable controller of claim 1, wherein a surface of the lower support which faces a lower portion of the wrist and a surface of the upper support which faces an upper portion of the wrist have an inwardly recessed shape, enabling the wrist to be stably seated in a recessed area, and the palm support is formed in a cylindrical shape having an oval cross-section elongated in the width direction, enabling user's fingers to wind or hold the palm support.

12. The wearable controller of claim 1, wherein the lower support and the palm support are integrally formed, and the connection member connects the lower support and the palm support integrally formed with the upper support.
